(19) United States
(12) Patent Application Publication
(10) Pub. No.: US 2013/0074645 A1
(43) Pub. Date: Mar. 28, 2013

(54) CONTROL LEVER FOR OPERATING A WORKING MACHINE

(71) Applicants: Jon Håkansson, Jokkmokk (SE); Jonny Lindblom, Eskilstuna (SE)

(72) Inventors: Jon Håkansson, Jokkmokk (SE); Jonny Lindblom, Eskilstuna (SE)

(21) Appl. No.: 13/516,248

(22) PCT Filed: Dec. 17, 2009
(86) PCT No.: PCT/SE2009/000525

§ 371 Date: Nov. 10, 2012

(51) Int. Cl. G05G 1/06

(52) U.S. Cl. CPC G05G 1/06
USPC 74/523

(57) ABSTRACT

A control lever is provided for operating a working machine. The control lever includes a base portion intended to be mounted to a working machine, and a top portion which is pivotally connected to the base portion for pivoting about a geometrical X-axis. The top portion is further adapted to be gripped and pivoted by an operator in order to operate the working machine, and the top portion has an outer gripping surface for receiving the palm of the hand of an operator. At least a part of the gripping surface is arranged adjacent to the geometrical X-axis in such a way that the geometrical X-axis is situated inside the hand and adjacent to the center part of the palm of the operator when the top portion is properly gripped by the operator.

### BACKGROUND AND SUMMARY

The invention relates to a control lever for operating a working machine, and an arm support arrangement for a working machine.

The invention is applicable on working machines within the fields of industrial construction machines, in particular excavators. Although the invention will be described with respect to an excavator, the invention is not restricted to this particular machine, but may also be used in other working machines, such as wheel loaders, articulated haulers, dump trucks or other construction equipment.

A working machine is provided with a bucket, container or other type of implement for digging, lifting, carrying and/or transporting a load. A working machine may be operated with large and heavy loads in areas where there are no roads, for example for transports in connection with road or tunnel building, sand pits, mines and similar environments. The machine has to be controlled with high precision at the same time as the terrain is very rough and bumpy. For example, during operation of an excavator the operator compartment is subjected to shakings and vibrations. This implies some problems since there is hard to control the working machine with high precision and there is also a risk of injury due to static muscular strain when the operator tries to work with the precision required.

A conventional joystick which has a pivot point is easily affected by unwanted movements of the operator's hand caused by the rough conditions. In order to solve this problem Joysticks which have an increased resistance against movement have been suggested. A disadvantage with such a joystick is that it will tend to cause muscular strain and fatigue in the hand and forearm of the operator.

It is desirable to provide a control lever defined by way of introduction, which control lever facilitates the control of a working machine during rough conditions.

By the provision of a control lever where at least a part of the gripping surface is arranged adjacent to the geometrical X-axis in such a way that the geometrical X-axis is situated inside the hand and adjacent to the centre part of the palm of the operator when the top portion being properly gripped by the operator, the operator's hand can rest on the control lever at the same time as the operator is able to use the control lever as a support by pressing the hand against the control lever in a direction towards the pivot point of the geometrical X-axis. The forearm of the operator can be positioned and orientated to extend in a direction which is substantially in line with the pivot point of the geometrical X-axis.

Hereby, an improved precision work can be performed and a more ergonomic operating position for the operator when controlling the working machine can be achieved. The invention is based on the insight that by means of a control lever which enables the operator to press the hand against the control lever, the stability can be increased and undesired movements of the top portion of the control lever due to shakings and/or vibrations can be counteracted or eliminated. Furthermore, if the forearm is subjected to an undesired force in the forward or backward direction, i.e. substantially in the extension direction of the forearm, the torque in the pivot point of the geometrical X-axis caused by this force will be considerably reduced compared to prior art control levers, since the lever arm with respect to the pivot point is substantially zero or close to zero. Thus, unintentional movements of the top portion can be counteracted.

By the expression pivoting about a geometrical “X-axis” is meant pivoting about an axis which enables the top portion of the control lever to be moved in the forward direction (away from the operator) and the backward direction (towards the operator) when the control lever is arranged in front of the operator. This definition of the X-axis is established with respect to conventional joysticks etc.

The other axes which can be defined for a joystick are the Y-axis and the Z-axis. The Y-axis enables movement of the joystick to the left and to the right with respect to the forward and backward direction. Finally the Z-axis enables the joystick to be pivoted about its own longitudinal extension axis. When the joystick is in an upright position usually corresponding to a neutral position the X-axis is horizontal. The Y-axis is horizontal and perpendicular to the X-axis and the Z-axis is perpendicular to the X-axis and the Y-axis. (The direction of the Z-axis relative to the X-axis and the Y-axis is however changed when the joystick is pivoted about the X-axis and Y-axis, respectively.) These definitions of the geometrical axes are used hereinafter when the control lever according to the invention is described.

According to one embodiment of the invention, the gripping surface has a front finger grip portion to be gripped by the fingers of an operator and a rear palm portion for supporting the palm of an operator, and a centre part of the rear palm portion is arranged closer to the geometrical X-axis compared to the front finger grip portion. Hereby, a more sensitive feeling can be achieved at the same time as a safe grip of the top portion is ensured.

Although the invention is disclosed herein with respect to a control lever with a top portion being pivotable about a geometrical X-axis, the basic idea of the invention can in the same way be applied to a control lever with a top portion being pivotable about a geometrical X-axis and/or a geometrical Y-axis.

By the provision of an arm support arrangement where the support surface of the arm rest and the geometrical X-axis are arranged at such a distance from each other that the forearm of an operator is situated substantially in line with the pivot point of the geometrical X-axis when the forearm resting against the support surface and the top portion being properly gripped by the operator, movements of the top portion caused by unintentional movements of the forearm in the forward and backward directions will be considerably reduced, since the lever arm with respect to the pivot point of the geometrical X-axis is substantially zero or close to zero.

The invention also relates to a working machine comprising a control lever according to the invention.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is an illustration of a joystick according to prior art,

FIG. 2 is a perspective view of a control lever according to the invention,

FIG. 3 is a lateral cross section view A-A of the control lever illustrated in FIG. 2,

FIG. 4 is a front view of the control lever illustrated in FIG. 2,

FIG. 5 is a top view of the control lever illustrated in FIG. 2,

FIG. 6 is a top view of a seat to be arranged in the operator compartment of an excavator, and

FIG. 7 is a lateral view of an arm support arrangement according to the invention.

### DETAILED DESCRIPTION

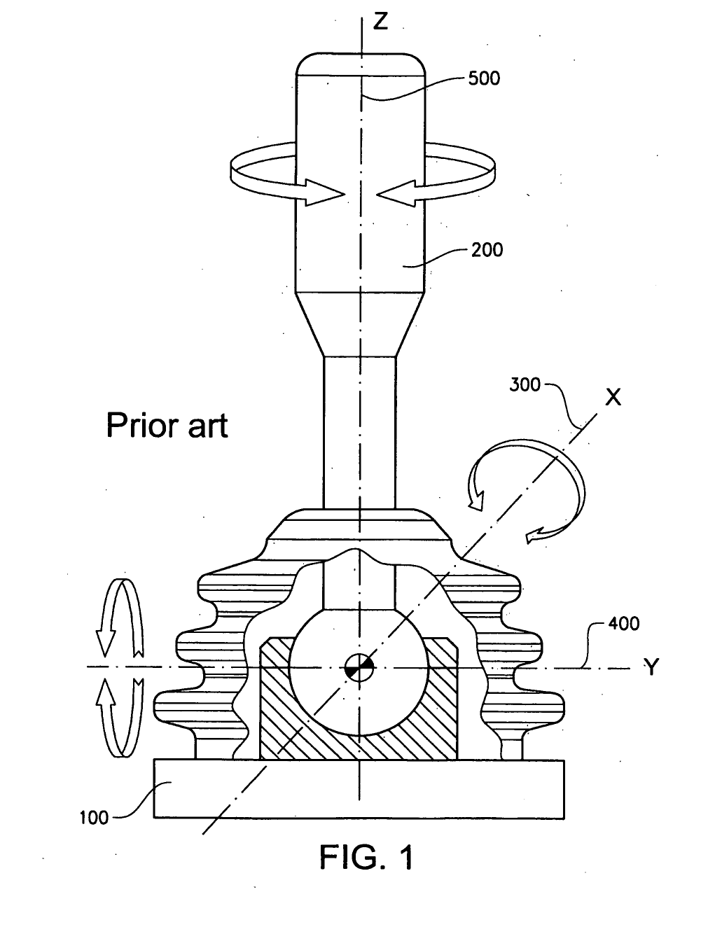

In FIG. 1 a joystick according to prior art is illustrated. The joystick has a base portion 100 and a top portion 200. The top portion is pivotally connected to the base portion for pivoting about a geometrical X-axis (extending perpendicularly relative to the plane of the paper in FIG. 1) 300. The top portion can also be pivoted about a geometrical Y-axis 400 and a geometrical Z-axis 500 as illustrated. The upper part of the top portion 200 is intended to be gripped by an operator in such a way that the fingers and the palm surround the Z-axis 500.

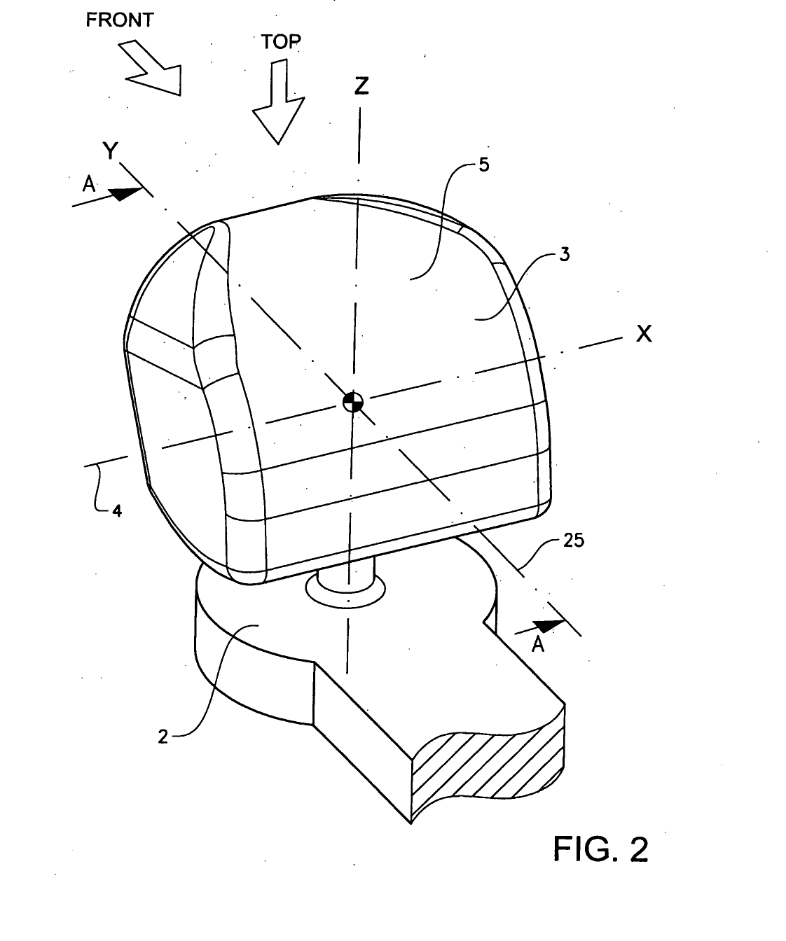

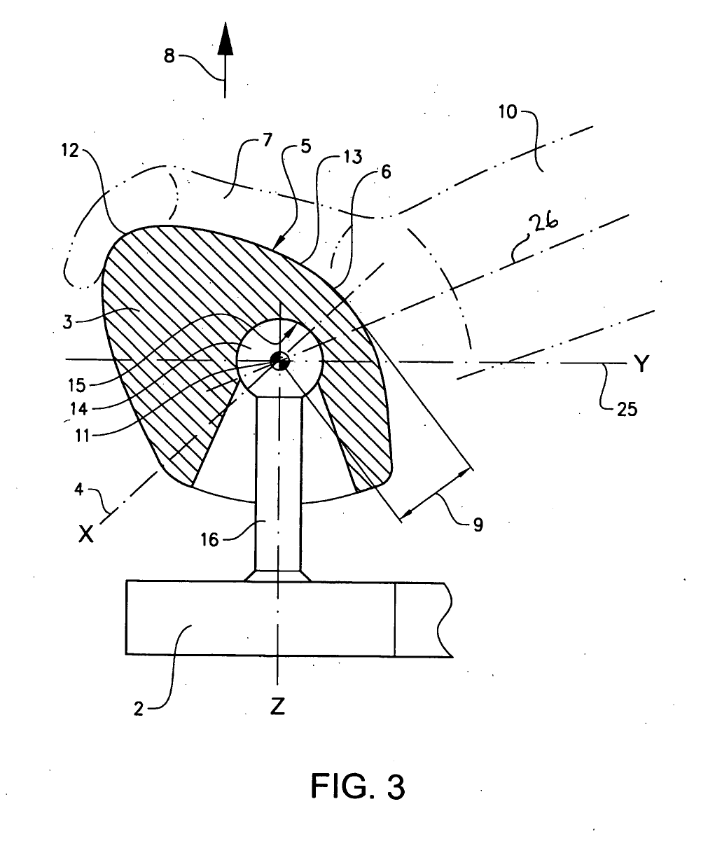

FIG. 2 is a perspective view of a control lever 1 according to the invention. The control lever 1 comprises a base portion 2 intended to be mounted to a working machine, and a top portion 3 which is pivotally connected to the base portion 2 for pivoting about a geometrical X-axis 4. The top portion 3 is adapted to be gripped and pivoted by an operator in order to operate the working machine and the top portion 3 has an outer gripping surface 5 for receiving the palm of the hand of the operator. As appears from FIG. 3, where a hand of an operator is also indicated, at least a part 6 of the gripping surface 5 is arranged adjacent to the geometrical X-axis 4 (extending perpendicularly relative to the paper plane in FIG. 3) such that the geometrical X-axis is situated inside the hand 7 and adjacent to the centre part of the palm of the operator when the top portion 3 being properly gripped by the operator. The control lever 1 is intended to be mounted with the main part of the gripping surface 5 faced upwardly 8 and to be gripped from above by the operator.

By the expression “the gripping surface is arranged adjacent” to the geometrical X-axis is meant that the gripping surface 6 is arranged at a distance 9 from the X-axis 4 (in a direction perpendicular to the X-axis) so as to enable the forearm 10 of an operator to be substantially in alignment with the pivot point 11 of the X-axis 4 when the control lever 1 is properly gripped. See FIG. 3 where the direction 26 of the forearm 10 intersects the pivot point 11. This implies that at least a part 6 of the gripping surface 5 arranged to receive the centre part of the palm is arranged in vicinity to the pivot point 11 or preferably in close vicinity of the pivot point 11.

Accordingly, the distance 9 between the X-axis and the current part 6 of the gripping surface 5 is relatively short. It has been shown that in most cases such a distance is suitably selected to be in the range 5-50 mm and often 5-30 mm. Such a distance 9 will enable the operator to press the hand against the top portion in a direction towards the pivot point 11, thereby counteracting vibrations and shakings from being transferred into undesired movements of the top portion 3 of the control lever 1. The forearm 10 of an operator can be directed substantially towards the pivot point 11, i.e. the forearm can be substantially aligned with the pivot point 11 of the geometrical X-axis 4, when the top portion 3 is gripped. Although the forearm 10 would not be exactly directed towards the pivot point, the control lever may constitute a support to the hand of the operator. However, during normal conditions it is preferred that the deviation from the pivot point is kept as low as possible in order to minimize the lever arm between the forearm 10 of the operator and the pivot point 11.

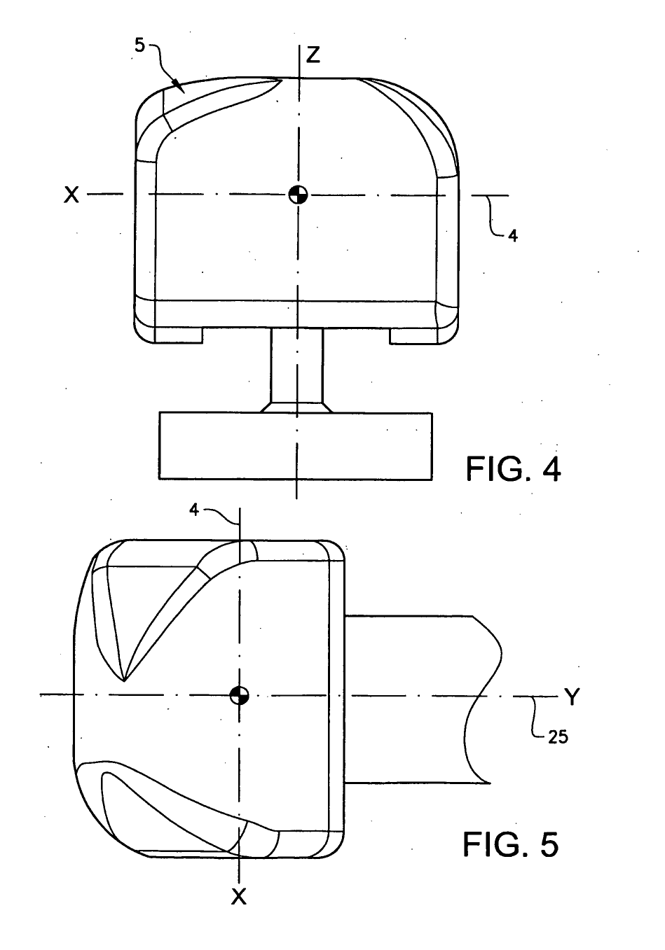

The gripping surface 5 is suitably shaped and sized to support substantially the entire palm including several or all fingers of the hand 7 of an operator to give a good support to the hand of the operator. The gripping surface 5 may have a considerable extension in the X-axis direction and the Y-axis direction for supporting the centre part of the palm of the operator, and preferably for supporting the major part of the palm of the hand of the operator. See also FIGS. 4 and 5.

As illustrated in FIG. 3, the extension of the gripping surface 5 in a direction substantially perpendicular to the X-axis may be of the same size as the length of a normal hand to suit the size of a hand for a 5-95 percentile operator. The length of the gripping surface (along the curved contour line of the top portion) supporting a hand may be selected to be in the range 120-240 mm and often in the range 140-220 mm. Preferably, the gripping surface 5 is arranged to at least partly surround or extend around the X-axis 4, and thereby in operation the fingers and the palm of the hand resting on the top portion will at least partly surround the X-axis. The gripping surface 5 illustrated in FIG. 3 is curved and partly surrounds the X-axis. In other words; the main shape of the gripping surface 5 is convex and the surface extends partly around the pivot point 11 when the control lever is viewed in the X-axis direction. The gripping surface may extend at least 60° around the pivot point or X-axis, and preferably at least 90° or at least 120° around the pivot point 11. In this matter the portion of the surface of the top portion 3 arranged to support the hand is considered.

The width of the gripping surface 6 in the X-axis direction is preferably of approximately the same size as the width of a normal hand to suit the size of a hand for a 5-95 percentile operator. The width is preferably may be selected in the range 70-120 mm and often in the range 80-110 mm. As appears from the front view in FIG. 4, the gripping surface 5 is somewhat curved. In other words; the main shape of the gripping surface is convex when the control lever is viewed in the Y-axis 25 direction as well as in the X-axis 4 direction.

In the embodiment example illustrated in FIG. 3, the gripping surface 5 has a front finger grip portion 12 to be gripped by the fingers of an operator and a rear palm portion 13 for supporting the palm of an operator. A centre part of the rear palm portion is preferably arranged closer to the geometrical X-axis 4 (or pivot point 11) compared to the front finger grip portion 12. As illustrated in FIG. 3, the front finger grip portion 12 and the rear palm portion 13 can be arranged at such a distance from each other that the centre part of the palm of the operator 7 is situated substantially at the centre part of the rear palm portion 13 when the top portion being properly gripped. Hereby, the hand of the operator is more or less automatically guided to the right position when the top portion being properly gripped, i.e. the fingers are positioned on the finger grip portion 12.

In order to achieve the geometrical X-axis (and a geometrical Y-axis and/or a geometrical Z-axis where appropriate) several different designs including prior art solutions can be used. In the embodiment illustrated, the base portion 2 has a ball 14 at the top thereof and the top portion 3 has a corresponding recess 15 for receiving the ball 14. The ball 14 and the surface 15 of the recess form the pivot point 11 providing the requisite geometrical axis (axes). Furthermore, the base portion 2 may be designed as a pillar 16, one first end of which is adapted to be mounted to a working machine and the other second end of which is pivotally connected to the top portion. Although in the illustrated embodiment the top portion 3 is provided with the recess 15 and the base portion 2 is provided with the ball 14, the same function can be achieved by providing the top portion with a ball and the base portion with a recess for receiving the ball. As already mentioned, also other arrangements using an axle, pin or similar can be used to provide a pivot axis so as to enable the top portion and the base portion to pivot relative each other about a geometrical X-axis.

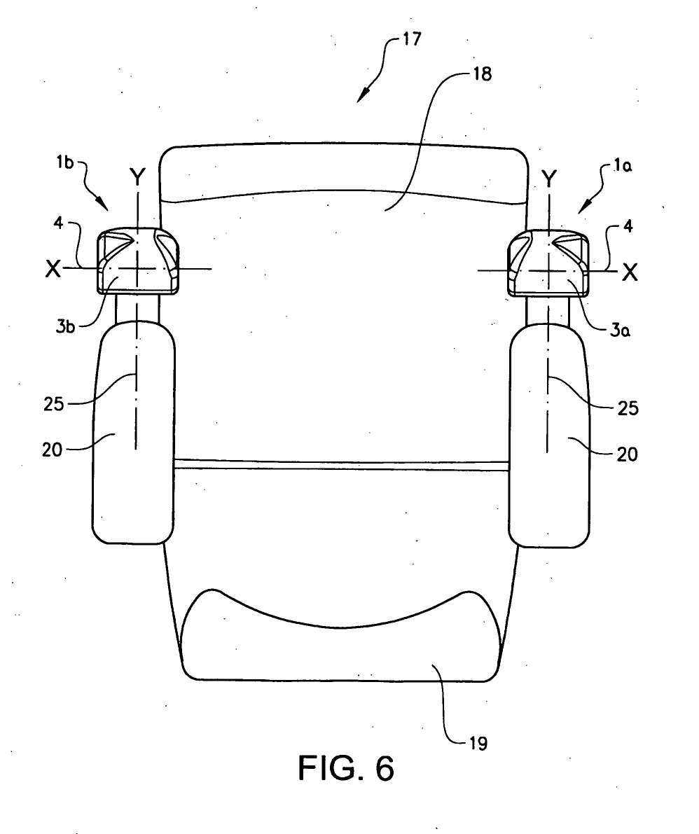

FIG. 6 is a top view of a seat 17 and two control levers 1a, 1b according to the invention are arranged at the seat 17. The seat 17 has a seat portion 18, a backrest 19 and two arm rests 20. The seat 17 is arranged in the operator compartment of an excavator. The control levers 1a, 1b are arranged at the right arm rest and the left arm rest, respectively. Each control lever is arranged in front of the arm rest to enable the operator to put the hand on the control lever at the same time as the forearm of the operator is supported by the arm rest.

Each control lever 1a, b is provided with at least two pivot axes, i.e. a geometrical X-axis 4 for movement of the top portion in the forward direction (away from the operator) and the backward direction (towards the operator) and a geometrical Y-axis 25 for movement of the top portion to the left and right. In the embodiment example the control levers are used for controlling the functions of the excavator. The top portions of the control levers are moved in accordance with the following pattern:

1. Stick Out: Left top portion 3b is moved in the forward direction

2. Stick In: Left top portion 3b is moved in the backward direction

3. Turn Left: Left top portion 3b is moved to the left

4. Turn Right: Left top portion 3b is moved to the right

5. Boom Lower: Right top portion 3a is moved in the forward direction

6. Boom Raise: Right top portion 3a is moved in the backward direction

7. Bucket Close: Right top portion 3a is moved to the left

8. Bucket Dump: Right top portion 3a is moved to the right

Thus, for the functions of items 1, 2, 5, and 6 the control lever is pivoted around the X-axis 4, and for the functions of items 3, 4, 7 and 8 the control lever is pivoted around the Y-axis 25. In addition, the control lever/levers can optionally be provided with a geometrical Z-axis for rotation of the top portion in order to obtain further functions controlled by pivoting the top portion to left or right. For example, the rotation of an implement can be controlled by rotation of the top portion around the Z-axis. Other functions may also be included in the control lever by providing the control lever with for example additional buttons and/or thumb-wheels.

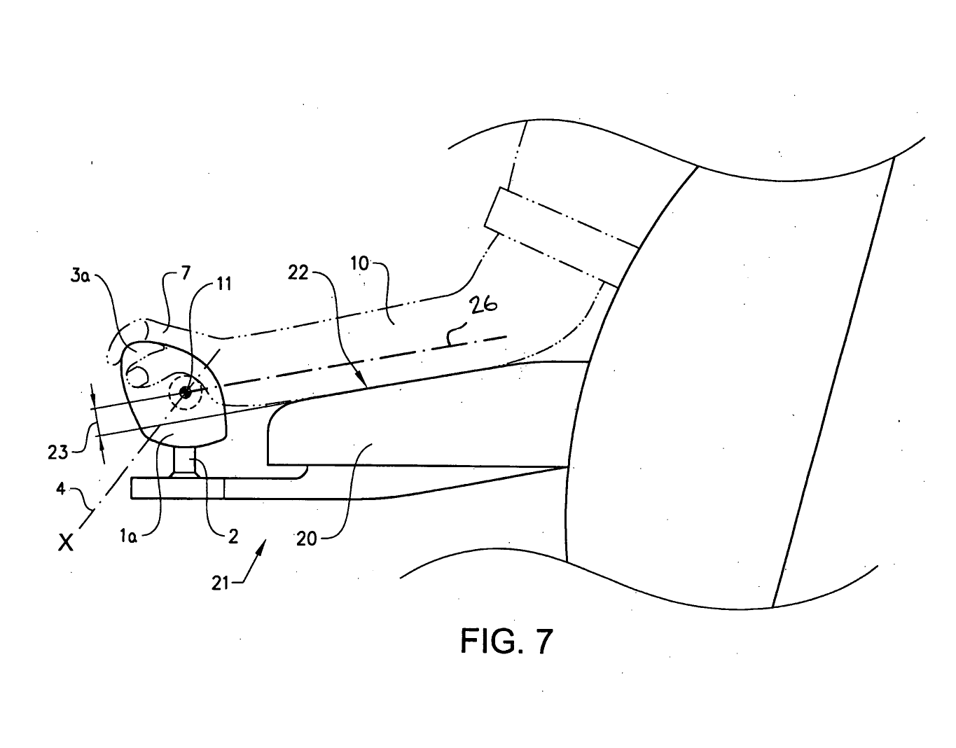

FIG. 7 shows in a lateral view an arm support arrangement 21 according to the invention. In FIG. 7 the right control lever 1a of FIG. 6 is illustrated together with the arm rest 20 in order to exemplify such an arm support arrangement. The arm support arrangement 21 comprises the arm rest 20 with a support surface 22 for supporting an arm 10 of an operator and a control lever 1a for operating a working machine. The control lever 1a can be designed according to any of the embodiments of the control lever previously described herein and with reference to FIGS. 2-6.

The control lever 1a has a base portion 2 arranged at the arm rest 20 and a top portion 3a which is pivotally connected to the base portion 2 for pivoting about a geometrical X-axis 4 (extending perpendicularly relative to the paper plane in FIG. 7) and adapted to be gripped and pivoted by an operator in order to operate the working machine. In the illustrated embodiment example the control lever 1a is arranged in front of the arm rest 20 to enable the forearm 10 of the operator to rest at the support surface 22 at the same time as the control lever 1a can be gripped by the operator's hand 7.

The support surface 22 of the arm rest 20 and the geometrical X-axis 4 are arranged at such a distance 23 from each other that the forearm 10 of an operator is situated substantially in line with the pivot point 11 of the geometrical X-axis when the forearm 10 resting against the support surface 22 and the top portion 3a being properly gripped by the operator. The support surface 22 is preferably arranged below the pivot point 11 of the X-axis. The distance 23 between the support surface 22 and the X-axis is preferably selected in the interval 5-50 mm, and more preferably in the interval 0-40 mm.

It is to be understood that the present invention is not limited to the embodiments described above and illustrated in the drawings; rather, the skilled person will recognize that many changes and modifications may be made within the scope of the appended claims.

1. A control lever for operating a working machine, comprising a base portion intended to be mounted to a working machine, and a top portion which is pivotally connected to the base portion for pivoting about a geometrical X-axis, and adapted to be gripped and pivoted by an operator in order to operate the working machine, the top portion having an outer gripping surface for receiving the palm of the hand of an operator, wherein at least a part of the gripping surface is arranged adjacent to the geometrical X-axis in such a way that the geometrical X-axis is situated inside the hand and adjacent to the centre part of the palm of the operator when the top portion being properly gripped by the operator.

2. A control lever according to claim 1, wherein the gripping surface is convex and the surface extends at least partly around the pivot point of the X-axis when the control lever is viewed in the X-axis direction.

3. A control lever according to claim 1, wherein the gripping surface has a front finger grip portion to be gripped by the fingers of an operator and a rear palm portion for supporting the palm of an operator.

4. A control lever according to claim 3, wherein a centre part of the rear palm portion is arranged closer to the geometrical X-axis compared to the front finger grip portion.

5. A control lever according to claim 3, wherein the front finger grip portion and the rear palm portion are arranged at such a distance from each other that the centre part of the palm of the operator is situated substantially at the centre part of the rear palm portion when the top portion being properly gripped.

6. A control lever according to claim 1, wherein the base portion has a ball at the top thereof and the top portion has a corresponding recess for receiving the ball so as to provide the geometrical X-axis.

7. A control lever according to claim 1, wherein the base portion is designed as a pillar, one first end of which is adapted to be mounted to a working machine and the other second end of which is pivotally connected to the top portion.

8. A control lever according to claim 1, wherein the gripping surface is adapted to support substantially the entire palm including the fingers of the hand of an operator.

9. A working machine comprising a control lever according to claim 1.

10. A control lever for operating a working machine, comprising a base portion intended to be mounted to a working machine, and a top portion which is pivotally connected to the base portion for pivoting about a geometrical Y-axis, and adapted to be gripped and pivoted by an operator in order to operate the working machine, the top portion having an outer gripping surface for receiving the palm of the hand of an operator, wherein at least a part of the gripping surface is arranged adjacent to the geometrical Y-axis in such a way that the geometrical Y-axis is situated inside the hand and adjacent to the centre part of the palm of the operator when the top portion being properly, gripped by the operator.

11. An arm support arrangement for a working machine, comprising an arm rest with a support surface for supporting an arm of an operator and a control lever for operating a working machine, the control lever having a base portion arranged at the arm rest and a top portion which is pivotally connected to the base portion for pivoting about a geometrical X-axis and adapted to be gripped and pivoted by an operator in order to operate the working machine, wherein the support surface of the arm rest and the geometrical X-axis are arranged at such a distance from each other that the forearm of an operator is situated substantially in line with the pivot point of the geometrical X-axis when the forearm resting against the support surface and the top portion being properly gripped by the operator.

12. A working machine comprising an arm support arrangement according to claim 11.
